(19) United States
(12) Patent Application Publication
(10) Pub. No.: US 2009/0327597 A1
(43) Pub. Date: Dec. 31, 2009

(54) DUAL INTERFACE MEMORY ARRANGEMENT AND METHOD

(75) Inventors: Hugues J. M. De Perthuis, Garcelles (FR); Eric Desmicht, Caen (FR)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/307,787

(22) PCT Filed: Jul. 10, 2007
(86) PCT No.: PCT/IB07/52726

§ 371 Date: Feb. 25, 2009

(30) Foreign Application Priority Data
Jul. 14, 2006 (EP) 06117212.8

(51) Int. Cl. G06F 12/00

(52) U.S. Cl. 711/105; 711/202; 711/E12.001

(57) ABSTRACT

The present invention provides for a dual interface memory arrangement employing the checkered memory mapping formed from combined vertically and horizontally sliced memory mapping, and including 2D access means arranged for access to the mapping memory wherein the said to the access means is arranged such that the access overlaps memory mapped to both interfaces both horizontally and vertically, and which arrangement preferably provides for two DTL channels for each interface wherein a highly efficient unified memory arrangement can be achieved for all processing aspects such as CPU, audio, video and gfx processing.

The present invention relates to a dual interface memory arrangement and related method. In particular the present invention relates to the manner in which data is mapped within the memory of, for example, an integrated circuit device arranged to offer a high definition Set Top Box (STB) based upon H264 compression.

Such integrated circuit devices comprise examples of commonly available devices requiring a large bandwidth due to the volume of data to be processed. Such high bandwidth arises particularly in relation to HD video decoding requirements.

Rather than employing a 32 bit DDR interface device for use in relation to such high-bandwidth scenarios, as an alternative it has been proposed that two 16 bit DDR interface devices be employed. With such 16 bit DDR devices, words can be fetched with a granularity equivalent to 32 bits, whereas a 32 bit DDR interface would lead to a granularity of 64 bits.

Also for, motion-compensation processing, it is found to be more effective to fetch a smaller bit word and so, again, employment of two 16 bit DDR interfaces can prove advantageous as compared with use a single 32 bit DDR interface.

Yet further, the efficiency imparted to the memory subsystem is also considered to be greater with a relatively narrow interface. For example, with a 16 bit interface, access times will be twice as long as with a 32 bit interface such that there are many more cycles available on the DDR command bus to prepare for the next access, while the current access is being executed.

However, limitations and potential disadvantages arise when employing dual interfaces, rather than a single interface, in particular, since the memory accesses have to be balanced between the two memories.

Various solutions have been proposed to overcome such limitations and which comprise the delineation of each interface for separate processing activities such as decoding and coding, and/or the alternative storage of images within one memory and then the other.

A more favoured solution comprises a dynamic method in which memory access is divided between the two interfaces depending upon the address employed and with a small granularity so that there is a mere 50/50 division of the load between the two interfaces and related memory regions.

Such a dynamic method advantageously provides flexibility and, to ensure that random access and linear access are evenly split, depending upon their required address and accesses, the memory mapping adopts a checkered pattern as, for example, is known from US2003/0122837.

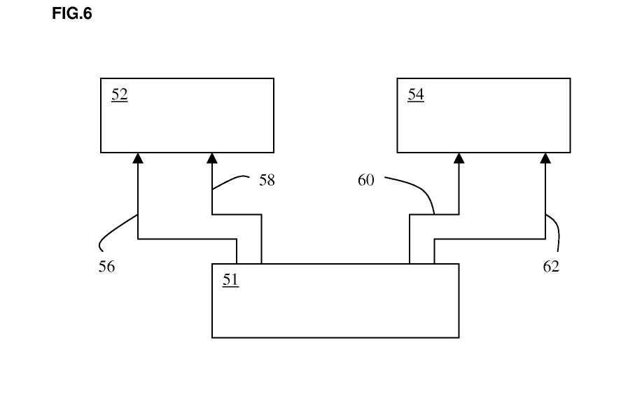

Here such a chequered pattern is disclosed in FIGS. 6 and 7, and the related passages of the description. However, it is found that the nature and manner of access to such a mapped memory arrangement is disadvantageously limited.

The present invention seeks to provide for a dual interface memory arrangement, and related method, having advantages over known such arrangements and methods.

According to a first aspect of the present invention, there is provided a dual interface memory arrangement employing checkered memory mapping formed from combined vertically and horizontally sliced memory mapping, and including 2D access means arranged for access to the mapped memory wherein the said access means is arranged such that an access overlaps memory which is mapped to both interfaces both horizontally and vertically.

Through the provision of such overlapping, the 2D access can advantageously cover more than two different adjacent memory locations, when considered both vertically and horizontally, so as to overcome limitations that are experienced in the current art.

In one embodiment, the dual interface memory arrangement can be arranged to generate one access for each line of the mapped memory.

According to another embodiment, the dual interface memory arrangement can be arranged to enforce use of a cache for accesses which straddle horizontal boundaries.

Such an arrangement advantageously limits the complexity of the memory interface since the cache can be arranged to transform normal accesses into aligned accesses.

Preferably, the dual interface memory arrangement can employ two separate Device Transaction Layer (DTL) channels for each interface.

Advantageously, one of the said two different channels is dedicated to data located to one side of the boundary defined by the access. That is, memory data that is active at every access. Further, the other interface can be dedicated to memory data located to the other side of the boundary, i.e. in which are only active in the case of an overlap.

Such an arrangement advantageously enhances the efficiency of the present invention.

Of course, it should be appreciated that the checkered memory mapping provided in accordance with the present invention can comprise double-checkered memory mapping.

According to another aspect of the present invention there is provided a dual interface memory control method including the provision of checkered memory mapping formed from a combination of vertical and horizontally sliced memory mapping, and including the steps of providing 2D access to the mapped memory, wherein said access overlaps memory mapped to both interfaces both horizontally and vertically.

In one embodiment, the dual interface memory method includes the generation of one access for each line of the mapped memory.

According to another embodiment, the dual interface memory includes the step of enforcing use of a cache for accesses which straddle horizontal boundaries.

The adoption of such further steps advantageously limits the complexity of the memory interface since the cache can be arranged to transform normal accesses into aligned accesses.

Preferably, the method can be provided by way of two separate DTL channels for each interface.

As above, within the method, one of the said two different channels is dedicated to data located to one side of the boundary defined by the access. That is, memory data that is active at every access. Further, the other interface can be dedicated to memory data located to the other side of the boundary, i.e. in which are only active in the case of an overlap.

Such an arrangement advantageously enhances the efficiency of the present invention.

Again, within the method it should be appreciated that the checkered memory mapping provided in accordance with the present invention can comprise double-checkered memory mapping.

The invention is described hereinafter, by way of example only, with reference to the accompanying drawings in which:

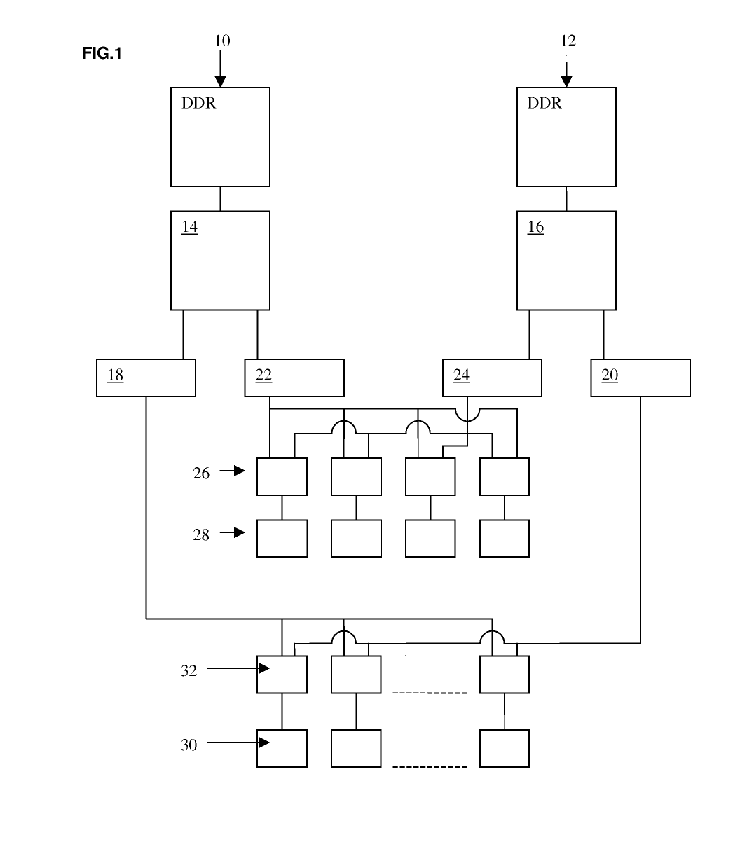

FIG. 1 is a block diagram of a memory subsystem which can be arranged for providing a checkered memory mapping pattern as related to the present invention;

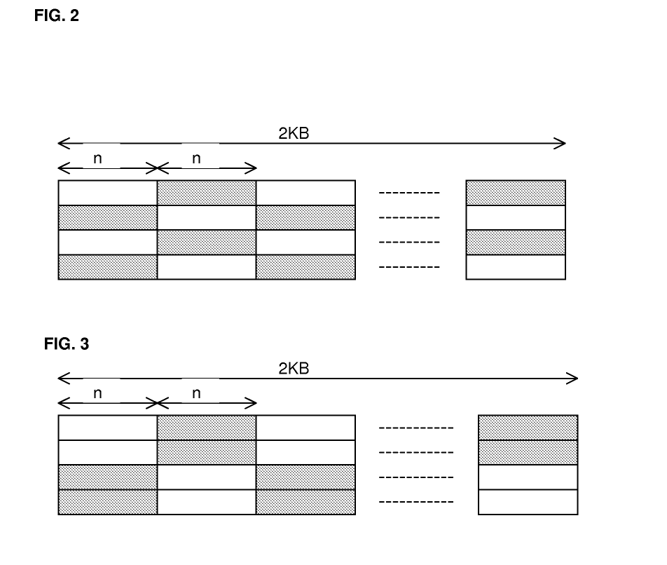

FIG. 2 illustrates a checkered memory mapping arrangement;

FIG. 3 illustrates a double-checkered memory mapping arrangement;

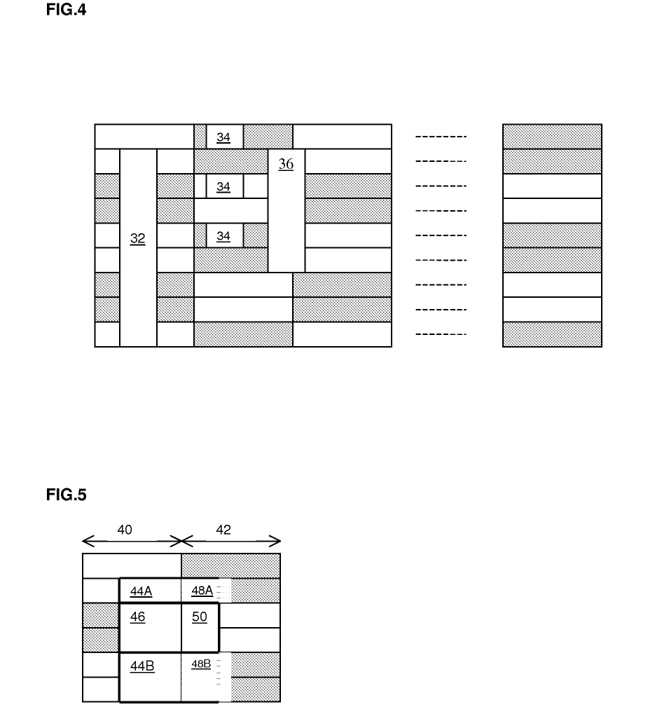

FIG. 4 is an illustration of a double-checkered memory mapping with different access patterns illustrated relative thereto;

FIG. 5 shows one aspect of FIG. 4 in greater detail and in accordance with an embodiment of the present invention; and

FIG. 6 is a block diagram of a 2D splitter DTL channel arrangement for use in accordance with the present invention.

Turning first to FIG. 1 there is provided an illustration of a memory subsystem that can be employed in accordance with an embodiment of the present invention so as to provide for a (double) checkered memory mapping pattern and which comprises parallel first 10 and second 12, sixteen bit memory subsystems.

As illustrated, each subsystem comprises a DDR subsystem employing DDR controller and Arbiter 14, 16, Central Data Memory Management Unit (CDMMU) 18, 20 and CPU Arbiter and MTL concentrated devices 22, 24 the latter of which lead to Router and CPU devices 26, 28.

Also, between a series of IP devices 30, and the CDMMU devices 18, 20 which control the buffering of all IP requests, there are provided splitter or router units 32. Each such splitter is arranged to receive a DTL access request and so as to split a such request in the direction of one of the two 16 bit memory subsystems responsive to the address and length of the DTL access. Each splitter is then arranged to receive data returned from the CDMMU, and to re-order that data, such that the IPs receive the data as if it originated from only one memory interface.

Through a combination of vertically and horizontally sized memory mapping, a checkered memory mapping pattern can be achieved as illustrated in FIG. 2. As will be appreciated, every n-byte, as an example every 64 bytes, the mapping alternates between the two memory interfaces.

Yet further, every 2 KB, the pattern alternating mapping is reversed so as to lead to the checkered pattern illustrated.

It has been identified that this is particularly efficient for both 1D and 2D accesses since the access provided between two memory interfaces.

A double-checkered memory mapping pattern such that illustrated in FIG. 3 is also known and can advantageously serve in overcoming problems should accesses be applied only to odd or even lines.

Such a double-checkered memory mapping pattern is particularly efficient for 1D and 2D interfaces since, in both directions, the access is split between the two memory interfaces.

The memory mapping arrangement advantageously allows for the use of dual 16 DDR interfaces instead of a single 32 bit interface through the aforementioned even splitting of the access onto both interfaces. This takes advantage of the inherent higher efficiency of employing two 16 bit interfaces such that a complete STB application can run with two 16 bit interfaces instead of two 32 bit interfaces which can otherwise be required, or with memories running at a lower speed.

Such memory mapping also allows for the support of a memory footprint greater than a single 32 bit interface. For example, 96 MB can be supported whereas a single interface would only allow for support for 64 MB or 128 MB.

Also, virtual mapping within which rows of data are stored horizontally rather than vertically can be regularly be accomplished in accordance with such double-checkered memory mapping so as to increase memory efficiency yet further.

Turning now to FIG. 4 there is provided a further illustration of a double-checkered memory mapping pattern with access configurations, one of which is provided in accordance with the present invention.

Referring again to H264 compression requirements, it should be noted that this allows for 4×4, 8×4, 4×8, 8×8, 8×16, 16×8 and 16×16 in regard to a lower pixel motion compensation patterns.

From luminance and chrominance requirements, it arises that every possible pattern between 1×1 and 20×21 pixels may be required. Since, when considered horizontally, pixels are fetched as a group of four, this dictates that every access from 1 to 6 words in a horizontal direction, and 1 to 21 lines in a vertical direction can be generated in both frame and field mode, 2×6×21 which=252 possibilities.

However, as illustrated further, the present invention can prove advantageous in allowing for the efficient handling of such requirements.

Remaining with FIG. 4, there is illustrated a double-checkered memory mapping pattern, such as that illustrated in FIG. 3 and to which three different access configurations have been applied.

The access configuration 32 maps solely in the vertical direction across both memory interfaces and the length of the access will therefore be different as presented to each of the two memory interfaces. With regard to the memory access configuration 34, this readily maps to both interfaces and, in view of the double-checkered pattern, access is generally evenly split between the two interfaces with the exception of accesses with an odd number of lines such as that illustrated in FIG. 4.

In accordance with a particular arrangement of an embodiment of the present invention, memory access configuration 36 overlaps adjacent differing regions both vertically and horizontally such that, for each memory interface, two accesses are interleaved. It then becomes necessary to access pixels located to the left and right of the slice boundary as represented by the access configuration 36.

While this represents a relatively complex access scheme, this can be achieved through the generation of one access for each line even though the efficiency of such arrangement might be questionable.

In accordance with another embodiment, two different DTL channels can be provided for each interface and wherein one channel is dedicated to pixels located to one side of the sliced boundary, i.e. which are active at every access, and the other channel can be dedicated to pixels located the other side of the sliced boundary, and employed only in the case of overlap arising.

Such an arrangement advantageously maintains, and can prove, efficiency.

In accordance with a further aspect, the invention can provide for the enforced use of cache memory for accesses which straddle horizontal boundaries to avoid over-complicating the memory interface since the cache memory transform all accesses into aligned accesses. If there are 512 pixel slices, there is then found to be straddling over the horizontal boundary in only a limited, in the region of 1.9%, number of cases.

The 2D access embodying the required overlap is illustrated in relation to FIG. 5 and as discussed in further detail below.

As will be appreciated, a 2D splitter will be arranged to transform one DTL request into multiple requests and each request will only access one row of one memory interface. The splitter is then arranged to cope with a vertical overlap that is an access covering two blocks and a horizontal overlap. Further, the splitter can be arranged to limit the maximum size of single 2D access to avoid creating long latency for other accesses. This can advantageously be controlled by way of a configuration register employing an algorithm arranged to:
check how many lines of the access can be addressed in the current row depending on the start address, mode (filled or framed) and the row width;
check the number of words which can be accessed in the row does not exceed the maximum allowed;
generate access such as from 1-4 commands; and
decrease the size of the access and start again if there are remaining lines.

Also, the related information recorded by the data FIFO for each command will be:
the number of words within a line or within the left-hand part of a horizontally overlapping access;
the number of words within the right-hand part of a horizontally overlapping access;
a number of lines to form a pattern that the lines are split on the two interfaces overlapping access; and
1 bit describing whether the access horizontally straddles two interfaces.

FIG. 5 is an example of a 2D access with a horizontal overlap as provided in accordance with an embodiment of the present invention. The illustration provides for an access of 5 words on 5 lines has encompassed within the boarder 38. The three words to the left of the slice boundary are illustrated by arrow 40, whereas the two words provided to the right of the sliced boundary are illustrated by arrow 42.

In view of the access of five words and five lines, it will be required to generate 4 DTL requests. For the portion to the left of the slice boundary, 1 DTL request of 3 words on 3 lines is illustrated by region 44A, and 44B and are directed to the first memory interface, whereas three words and two lines as illustrated by region 46 is provided on the second memory interface.

With regard to the regions to the right of the sliced boundary, two words on three lines illustrated by regions 48A and 48B are provided for the second memory interface, whereas two words on two lines as illustrated by the region 50B are provided for the first memory interface.

Turning now to FIG. 6, there is provided a schematic block diagram of a 2D splitter 51 DTL channel setup for providing the memory accesses as illustrated in relation to FIGS. 4 and 5.

This serves to illustrate the two CDU devices 52, 54 each provided with two DTL channels 56, 58; 60, 62.

With the example illustrated in relation to FIG. 5, it should be appreciated that the data FIFO will record the following:
the number of words in a line for left-hand access;
the number of words in a line for right-hand access;
the number of lines,
the pattern: frame access starting at odd line in interface 1; and
straddling access; yes.

Armed with such information, the motion compensation of the splitter 51 such as that illustrated in FIG. 6 can serve to re-order data arriving on each DTL channel.

Through adoption of the present invention, it should be appreciated that a variety of advantages can arise particularly when handling video data content. Unified memory between all processes (CPU, audio, video, gfx) can be provided as compared with a separate memory interface for CPU and video decoding which would result in a larger, and less economical, footprint. A more efficient memory is also provided since less data has to be fetched and also because access on each DDR is longer and this allows more efficient handling of DDR commands.

The invention can also take into account banks in memory, by applying the same principle to split access in each memory. In particular efficient balancing of access between each memory can support an asymmetric footprint 96, 192 MB. The same mapping is used for all IP and is transparent to the IPs, so it means that there is no artificial walls between IPs, and so, as an example, the CPU can access gfx or video data without restrictions.

1. A dual interface memory arrangement employing checkered memory mapping formed from combined vertically and horizontally sliced memory mapping, and including 2D access means arranged for access to the mapped memory wherein the said access means is arranged such that an access overlaps memory mapped to both interfaces both horizontally and vertically.

2. A memory arrangement as claimed in claim 1 and arranged to generate one access for each line of the mapped memory.

3. A memory arrangement as claimed in claim 1 and arranged to enforce use of a cache for accesses which straddle horizontal boundaries of the mapped memory.

4. A memory arrangement as claimed in claim 1 and employing two separate DTL channels for each interface.

5. A memory arrangement as claimed in claim 4 wherein one of the said two different channels is dedicated to pixels located to one side of the boundary defined by the access.

6. A memory arrangement as claimed claim 1 wherein one of the said two interfaces is dedicated to memory data located to one side of the boundary.

7. A dual interface memory control method including the provision of checkered memory mapping formed from a combination of vertically and horizontally sliced memory mapping, and including the steps of providing 2D access to the mapped memory, wherein said access overlaps memory mapped to both interfaces both horizontally and vertically.

8. A method as claimed in claim 7, and including the step of generating one access for each line of the mapped memory.

9. A method as claimed in claim 7, and including the step of enforcing use of a cache for accesses which straddle horizontal boundaries.

10. A method as claimed in claim 7 and employing two separate DTL channels for each interface.

11. A method as claimed in claim 10, wherein one of the said two different channels is dedicated to pixels located to one side of a boundary defined by the access.

12. (canceled)
